(19) United States
(12) Patent Application Publication
(10) Pub. No.: US 2025/0381917 A1
(43) Pub. Date: Dec. 18, 2025

(54) STORAGE SYSTEM FOR A MOTOR VEHICLE WITH A PLURALITY OF SYSTEM INSERTS WITH THE SAME EXTERNAL GEOMETRY AND MOTOR VEHICLE WITH SUCH A STORAGE SYSTEM

(71) Applicant: AUDI AG, Ingolstadt (DE)

(72) Inventors: Jacques HELOT, Ingolstadt (DE); Christian WALL, Hitzhofen (DE)

(73) Assignee: AUDI AG, Ingolstadt (DE)

(21) Appl. No.: 19/215,479

(22) Filed: May 22, 2025

(30) Foreign Application Priority Data
Jun. 14, 2024 (DE) 102024116774.2

(51) Int. Cl. B60R 7/08; B60N 3/10

(52) U.S. Cl. CPC B60R 7/08; B60N 3/10

(57) ABSTRACT

A storage system for a motor vehicle, with a plurality of system receptacles; a plurality of system inserts. The system inserts have a uniform external geometry. Each system receptacle has a receiving space corresponding to the external geometry of the system inserts, such that each system insert can be positioned in each system receptacle. At least two of the plurality of system inserts have a different insert space division arranged within the uniform external geometry.

### FIELD

The invention relates to a storage system for a motor vehicle with a plurality of system receptacles; a plurality of system inserts; wherein the system inserts have a uniform external geometry; wherein each system receptacle has a receiving space corresponding to the external geometry of the system inserts, such that each system insert can be positioned in each system receptacle.

### BACKGROUND

Various approaches to storage options in the region of a motor vehicle's center console are known from the prior art. Reference is made, for example, to DE 199 08 139 A1 and DE 10 2006 048 565 A1.

Previously known storages in motor vehicles do not offer the possibility of systematically accommodating different external components. For example, it is not possible to store beverage containers such as bottles, cans or cups, or a plurality of storage boxes for food or other cargo, in a compartment of a center console.

### SUMMARY

The object of the invention is to provide a storage system for a motor vehicle in which the above disadvantages are avoided and in particular a systematic and, if necessary, interchangeable storage of different loads is made possible.

A storage system for a motor vehicle is thus proposed, having
a plurality of system receptacles; a plurality of system inserts; wherein the system inserts have a uniform external geometry; and wherein each system receptacle has a receiving space corresponding to the external geometry of the system inserts, such that each system insert can be positioned in each system receptacle. It is provided that at least two of the plurality of system inserts have a different insert space division arranged within the uniform external geometry.

This makes it possible to provide at least two system inserts which are essentially identical in terms of their external dimensions and shape, but have an interior insert space which is prepared to accommodate different loads by means of the respective insert space division. This means that different loads can be stowed within a corresponding system insert and the system inserts can each be arranged in any system receptacle.

In the storage system, the system inserts may have a handle that is movable between a carrying position and a receiving position. This allows a system insert to be easily grasped and inserted into or removed from a system receptacle. Furthermore, the system inserts can be removed from a system receptacle and carried to another location by an operator.

In the storage system, each system insert can have an insert base and at least two insert walls connected to the insert base. In other words, a system insert can have at least three boundary walls that are arranged approximately in a U-shape (with rounded corners if necessary).

In the storage system, each system insert can have three insert walls and be freely accessible to the front and/or top. This allows the system insert to be designed to be sufficiently stable and at the same time optimally accessible for a specific purpose.

In the storage system, one of the system inserts may have a removable insert lid. The insert lid can be designed separately from the above-mentioned handle, so that the system insert can be carried with or without the insert lid. However, it is also conceivable that the insert lid has a carrying handle, so that a corresponding system insert can only be transported with the insert lid arranged on it and firmly connected.

In the storage system, the insert space division of one of the system inserts can have at least one substantially horizontally arranged shelf, such that at least two insert compartments accessible from the front are formed.

The storage system can also have storage boxes that are tailored to the dimensions of the insert compartments and that can be inserted into and removed from each insert compartment.

In the storage system, the insert space division of one of the system inserts can have at least one substantially horizontally arranged holder with a plurality of holder openings, such that a plurality of beverage container holders accessible from above are formed. The holder openings can be circular and have a diameter that is slightly larger than usual beverage containers, such as bottles, cans, drinking cups or the like.

In the storage system, the system inserts can be used separately from the system receptacles, in particular they can be transported by an operator in the carrying position by means of the handle.

If, for example, food and/or drinks are transported using the system inserts, the system inserts can be removed from the vehicle during a break in the journey and taken to a dining area. The system inserts can also be pre-stocked with food and/or drinks, for example in a kitchen, and then stored in the respective system receptacles in a motor vehicle before starting the journey.

A motor vehicle can be equipped with a storage system as described above, wherein at least two system receptacles are arranged in the motor vehicle at different positions in the vehicle interior. For example, one system receptacle may be provided in a center console between the front seats of the motor vehicle and another system receptacle may be provided in the region of a backrest of a rear row of seats. It is also possible to arrange at least one system receptacle in a luggage compartment (trunk).

In the motor vehicle, one of the system receptacles may be positioned so that it is accessible from outside the motor vehicle. For example, the system receptacle can be arranged very close to a luggage compartment lid, so that direct access to the system receptacle is possible when the luggage compartment lid is open. However, it is also conceivable that an additional flap is provided on the body side of the vehicle, behind which a system receptacle is arranged.

### BRIEF DESCRIPTION OF THE FIGURES

Further advantages and details of the invention will become apparent from the following description of embodiments with reference to the figures. In particular:

FIG. 1 shows a simplified and schematic view of a motor vehicle with a storage system;

FIG. 2 shows a simplified and schematic embodiment of a system insert;

FIG. 3 shows a simplified and schematic embodiment of a system insert;

FIG. 4 shows simplified and schematic further embodiments of a system insert;

FIG. 5 shows a simplified and schematic illustration of the use of a system insert outside a motor vehicle.

### DETAILED DESCRIPTION

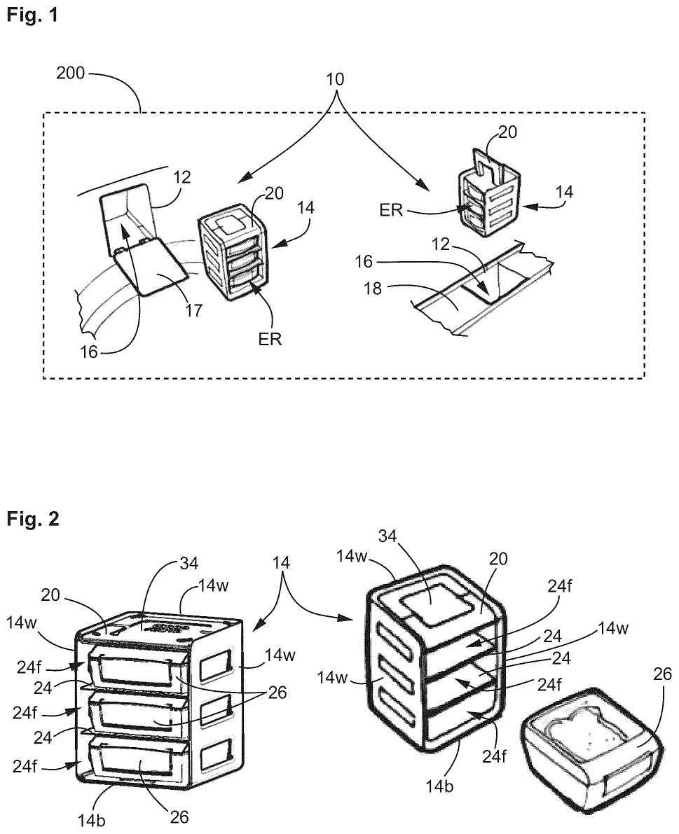

FIG. 1 shows a simplified and schematic view of a storage system 10 for a motor vehicle 200, illustrated here only as a dashed rectangle.

The storage system 10 comprises a plurality of system receptacles 12 and a plurality of system inserts 14. The system inserts 14 have a uniform external geometry or external shape. In particular, external dimensions such as height, width and depth of the system inserts are kept identical.

Each system receptacle 12 has a receiving space 16 corresponding to the external geometry or shape of the system inserts 14, such that each system insert 14 can be positioned or arranged in each system receptacle 12.

In the example of FIG. 1, the two system receptacles 12 are arranged in the motor vehicle 200 at different positions in a vehicle interior not shown in detail here. The system receptacle 12 shown on the left in FIG. 1 can, for example, be arranged laterally in a luggage compartment (trunk) or a side interior panel. The system receptacle 12 shown on the right in FIG. 1 can, for example, be arranged in a center console 18, which is only indicated here, for example between two front seats of the motor vehicle 200.

The positions of system receptacles 12 illustrated in FIG. 1 are purely exemplary. It is also conceivable that two system receptacles 12 are arranged one behind the other in the center console 18 in a longitudinal direction of the vehicle. Furthermore, a system receptacle 12 can also be provided between rear seats or in the area of a backrest of a rear seat bench. It is also conceivable to provide a system receptacle 12 in the region of a glove compartment.

In the motor vehicle 200, one of the system receptacles 12 may also be positioned so that it is accessible from outside the motor vehicle 200.

As can be seen from FIG. 1 in the left illustration, a system receptacle 12 or its receptacle space 16 can be covered by a flap 17 (shown here in the open state) or can be closed by the flap 17. The system receptacle 12 or the receiving space 16 is dimensioned such that the flap 17 can also be closed with the system insert 14 accommodated therein.

In FIG. 1, two system inserts 14 are shown purely as examples, which are of identical design.

The system inserts 14 each have a handle 20 which is movable between a carrying position (shown on the right in FIG. 1) and a receiving position (shown on the left in FIG. 1).

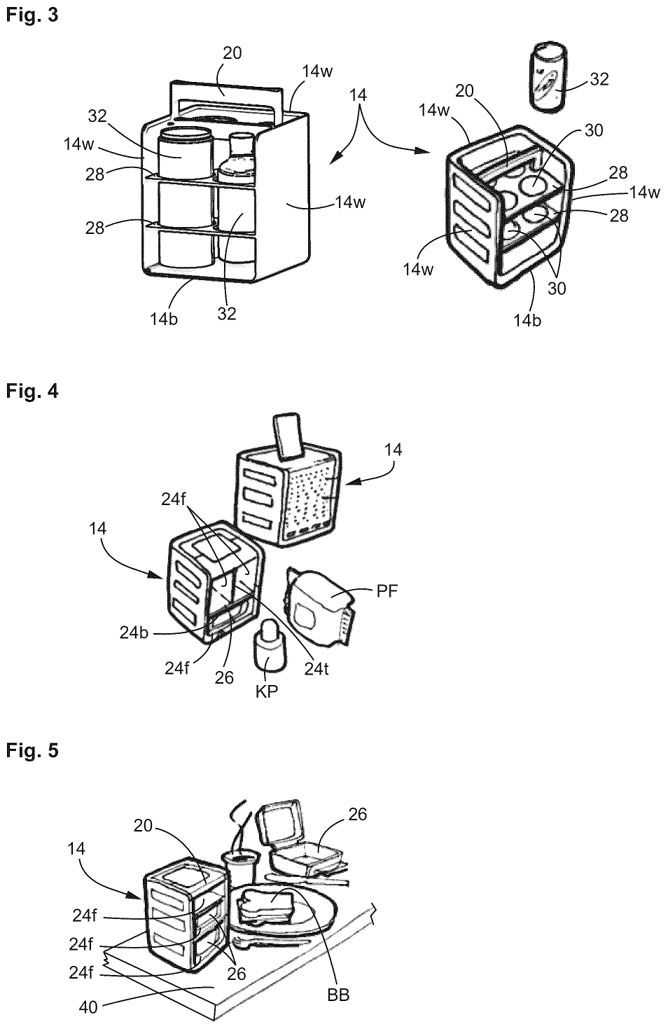

In the receiving system 10, at least two of the plurality of system inserts 14 have a different insert space division ER arranged within the uniform external geometry, which is described below by way of example with reference to FIGS. 2 and 3.

In FIG. 2, a system insert 14 is shown from slightly different perspectives, in which the insert space division has two essentially horizontally arranged shelves 24, such that at least three insert compartments 24f accessible from the front are formed.

In particular, suitable storage boxes 26 can be inserted or are inserted into the insert compartments 24f. The storage boxes can contain food or other items such as cutlery or napkins or the like, for example.

It should be noted that the design with two shelves 24 and three insert compartments 24f is purely exemplary. Only one shelf 24 or more than two shelves 24 may be provided.

In FIG. 3, a system insert 14 is shown from slightly different perspectives, in which the insert space division has two substantially horizontally arranged holders 28 with a plurality of holder openings 30, such that a plurality of holders accessible from above for beverage containers 32, such as bottles or cans or the like, are formed.

As can be seen from FIGS. 2 and 3, each system insert 14 has an insert base 14b and at least two insert walls 14w connected to the insert base. In particular, each system insert 14 can have three insert walls 14w, wherein it is freely accessible to the front and/or upwards.

The system insert 14 shown in FIG. 2 has a particularly removable insert lid 34. In the example shown, the insert lid 34 can also be firmly connected to the insert walls 14w. For example, the handle 20 can be movably connected to the insert lid 34 or two insert walls 14w.

FIG. 4 illustrates two further configuration options for the insert space division of system inserts 14.

The system insert 14 shown at the bottom left has two separate insert compartments 24f in an upper region, which are separated from each other by a vertical partition wall 24t. Below this, a further insert compartment 24f is formed by means of a shelf 24b, in which a receiving box 26 is arranged. With such a division of the system insert 14, for example, further items such as packs for fresh wipes PF or cosmetic products KP can be stored.

The system insert 14 shown at top right has a loudspeaker 42 accommodated therein. Such a system insert 14 can, for example, also have a battery unit (not shown here) which can be used to charge a mobile phone 44 or the like, in particular when the mobile phone 44 is used to play audio files by means of the loudspeaker 42. Such a system insert 14 with loudspeaker can be used, for example, outside the motor vehicle 200.

FIG. 5 illustrates in a simplified manner that a system insert 14 (or a plurality of system inserts 14) can be used separately from the system receptacles 12 (see FIG. 1), for example on a storage surface 40, which is only indicated here, such as a table or the like. In particular, the system inserts 14 can be transported by an operator in the carrying position by means of the handle 20. From the example of FIG. 5 it can be seen, for example, that a storage box 26 has been removed from the system insert 14 and opened in order to be able to remove a sandwich BB.

The storage box 26 shown in the top right corner of FIG. 5 was, for example, accommodated in the uppermost insert compartment 24f, which is shown empty here. The two other compartments 24f still contain respective storage boxes 26.

In summary, a combination of different system inserts 14 (receiving units or racks) is proposed, which can be stowed in the motor vehicle 200 at various locations, such as the center console, front and rear areas, trunk, with external access via flaps on the external body, etc. The storage options are standardized in terms of size with respect to the system inserts 14 or racks and offer a unique positioning option at each location that is tailored to the system insert 14, so that each system insert 14 or each rack can be stowed in each standardized storage location (system receptacle 12).

1. A storage system for a motor vehicle, comprising:
a plurality of system receptacles;
a plurality of system inserts;
wherein the system inserts have a uniform external geometry;
wherein each system receptacle has a receiving space corresponding to the external geometry of the system inserts, such that each system insert can be positioned in each system receptacle;
wherein at least two of the plurality of system inserts have a different insert space division arranged within the uniform external geometry.

2. The storage system according to claim 1, wherein the system inserts have a handle which is movable between a carrying position and a receiving position.

3. The storage system according to claim 1, wherein each system insert has an insert base and at least two insert walls connected to the insert base.

4. The storage system according to claim 3, wherein each system insert has three insert walls and is freely accessible to the front and/or to the top.

5. The storage system according to claim 3, wherein one of the system inserts has a removable insert lid.

6. The storage system according to claim 1, wherein the insert space division of one of the system inserts has at least one substantially horizontally arranged shelf such that at least two insert compartments accessible from the front are formed.

7. The storage system according to claim 1, wherein the insert space division of one of the system inserts has at least one substantially horizontally arranged holder with a plurality of holder openings such that a plurality of receptacles for beverage containers accessible from above are formed.

8. The storage system according to claim 1, wherein the system inserts can be used separately from the system receptacles, in particular can be transported by an operator in the carrying position by means of the handle.

9. A motor vehicle with a storage system according to claim 1, wherein in the motor vehicle at least two system receptacles are arranged at different positions in the vehicle interior.

10. The motor vehicle according to claim 9, wherein one of the system receptacles is positioned so that it is accessible from outside the motor vehicle.

11. The storage system according to claim 2, wherein each system insert has an insert base and at least two insert walls connected to the insert base.

12. The storage system according to claim 4, wherein one of the system inserts has a removable insert lid.

13. The storage system according to claim 2, wherein the insert space division of one of the system inserts has at least one substantially horizontally arranged shelf such that at least two insert compartments accessible from the front are formed.

14. The storage system according to claim 3, wherein the insert space division of one of the system inserts has at least one substantially horizontally arranged shelf such that at least two insert compartments accessible from the front are formed.

15. The storage system according to claim 4, wherein the insert space division of one of the system inserts has at least one substantially horizontally arranged shelf such that at least two insert compartments accessible from the front are formed.

16. The storage system according to claim 5, wherein the insert space division of one of the system inserts has at least one substantially horizontally arranged shelf such that at least two insert compartments accessible from the front are formed.

17. The storage system according to claim 2, wherein the insert space division of one of the system inserts has at least one substantially horizontally arranged holder with a plurality of holder openings such that a plurality of receptacles for beverage containers accessible from above are formed.

18. The storage system according to claim 3, wherein the insert space division of one of the system inserts has at least one substantially horizontally arranged holder with a plurality of holder openings such that a plurality of receptacles for beverage containers accessible from above are formed.

19. The storage system according to claim 4, wherein the insert space division of one of the system inserts has at least one substantially horizontally arranged holder with a plurality of holder openings such that a plurality of receptacles for beverage containers accessible from above are formed.

20. The storage system according to claim 5, wherein the insert space division of one of the system inserts has at least one substantially horizontally arranged holder with a plurality of holder openings such that a plurality of receptacles for beverage containers accessible from above are formed.
